(19) United States
(12) Patent Application Publication
(10) Pub. No.: US 2015/0062476 A1
(43) Pub. Date: Mar. 5, 2015

(54) DISPLAY SUBSTRATE AND DISPLAY APPARATUS INCLUDING THE SAME

(71) Applicant: Samsung Display Co., Ltd., Yongin-city (KR)

(72) Inventors: Young-Wan SEO, Suwon-si (KR); Yeong-Keun KWON, Yongin-si (KR); Ji-Sun KIM, Seoul (KR); Chong-Chul CHAI, Seoul (KR)

(73) Assignee: Samsung Display Co., Ltd., Yongin-city (KR)

(21) Appl. No.: 14/227,831

(22) Filed: Mar. 27, 2014

(30) Foreign Application Priority Data
Sep. 3, 2013 (KR) 10-2013-0105174

(51) Int. Cl. G02F 1/1343

(52) U.S. Cl. CPC G02F 1/134309
USPC 349/46

(57) ABSTRACT

A display substrate includes thin film transistors, first common voltage lines, and second common voltage lines. Each thin film transistor includes a gate electrode, a source electrode, and an annulus-shaped drain electrode. The first common voltage lines are disposed adjacent to first sides of the gate electrodes. The second common voltage lines are disposed adjacent to second sides of the gate electrodes.

### CROSS-REFERENCE TO RELATED APPLICATION

This application claims priority from and the benefit of Korean Patent Application No. 10-2013-0105174, filed on Sep. 3, 2013, which is incorporated by reference for all purposes as if set forth herein.

### BACKGROUND

1. Field

Exemplary embodiments relate to display technology, and, more particularly, to a display substrate with improved reliability and a display apparatus including the same.

2. Discussion

A conventional liquid crystal display (“LCD”) apparatus typically includes a display substrate and an opposite (or second) substrate facing the display substrate. According to the arrangement of liquid crystal molecules in a liquid crystal layer disposed between the display substrate and the opposite substrate, a transmittance of light passing through the liquid crystal layer may be adjusted (or otherwise controlled) so that a desired image may be displayed. The conventional liquid crystal display apparatus may include a display panel and a light source to provide the light to the display panel. A backlight assembly of the liquid crystal display apparatus may include the light source. The light emitted from the light source may be provided to the display panel, which typically includes the display substrate and the opposite substrate.

It is noted that the display substrate may include a thin film transistor (TFT) array for controlling each pixel of an arrangement of pixels configured in association with the display panel. If, however, elements (or components) of a TFT of the TFT array are misaligned, a parasitic capacitance may be formed between the elements of the TFT and other electrodes of the liquid crystal display apparatus. The parasitic capacitance may change or degrade electrical characteristics of the TFT, as well as display quality of the liquid crystal display apparatus.

The above information disclosed in this Background section is only for enhancement of understanding of the background of the inventive concept, and, therefore, it may contain information that does not form the prior art that is already known in this country to a person of ordinary skill in the art.

### SUMMARY

One or more exemplary embodiments provide a display substrate with improved reliability and display quality.

One or more exemplary embodiments provide a display apparatus including a display substrate with improved reliability and display quality.

Additional aspects will be set forth in the detailed description which follows, and, in part, will be apparent from the disclosure, or may be learned by practice of the inventive concept.

According to exemplary embodiments, a display substrate includes thin film transistors, first common voltage lines, and second common voltage lines. Each thin film transistor includes a gate electrode, a source electrode, and an annulus-shaped drain electrode. The first common voltage lines are disposed adjacent to first sides of the gate electrodes. The second common voltage lines are disposed adjacent to second sides of the gate electrodes.

According to exemplary embodiments, a display apparatus includes a first substrate, a second substrate, and a liquid crystal layer. The first substrate includes thin film transistors, first common voltage lines, and second common voltage lines. Each thin film transistor includes a gate electrode, a source electrode, and an annulus-shaped drain electrode. The first common voltage lines are disposed adjacent to first sides of the gate electrodes. The second common voltage lines are disposed adjacent to second sides of the gate electrodes. The second substrate faces the first substrate. The liquid crystal layer is disposed between the first substrate and the second substrate.

According to exemplary embodiments, a display substrate includes a thin film transistor including a drain electrode having a ring (or annulus) shape. Even though the drain electrode may shift in a first direction or a direction opposite the first direction, an overlapped area between the drain electrode and the gate electrode may remain constant. That is, a parasitic capacitance between the drain electrode and the gate electrode may remain constant. Further, even though the drain electrode may shift in a second direction or a direction opposite the second direction, an overlapped area between the drain electrode and the first and second common voltage lines may remain constant. As such, a storage capacitance may also remain constant.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic diagram illustrating an electrical structure of a display substrate, according to exemplary embodiments.

FIG. 2 is a plan view of region A of FIG. 1, according to exemplary embodiments.

FIG. 3 is an enlarged plan view of FIG. 2, according to exemplary embodiments.

FIG. 4 is a cross-sectional view taken along sectional line I-I′ of FIG. 3, according to exemplary embodiments.

FIGS. 5A and 5B are respective plan views illustrating a change in overlapped area between a drain electrode and a gate electrode, according to exemplary embodiments.

FIGS. 6A and 6B are respective plan views illustrating a change in overlapped area between a drain electrode and a gate electrode, according to exemplary embodiments.

FIG. 7 is an enlarged plan view illustrating a display substrate, according to exemplary embodiments.

FIG. 8 is a cross sectional view illustrating a display substrate, according to exemplary embodiments.

FIGS. 9 to 17 are plan views and cross-sectional views illustrating a method of manufacturing a display substrate, according to exemplary embodiments.

FIG. 18 is a cross sectional view illustrating a display apparatus, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Although various exemplary embodiments are described with respect to a liquid crystal display implementation, it is contemplated that various exemplary embodiments are also applicable to other display technologies, such as, for example, organic light emitting displays, plasma displays, field emission displays, electrophoretic displays, electrowetting displays, and the like.

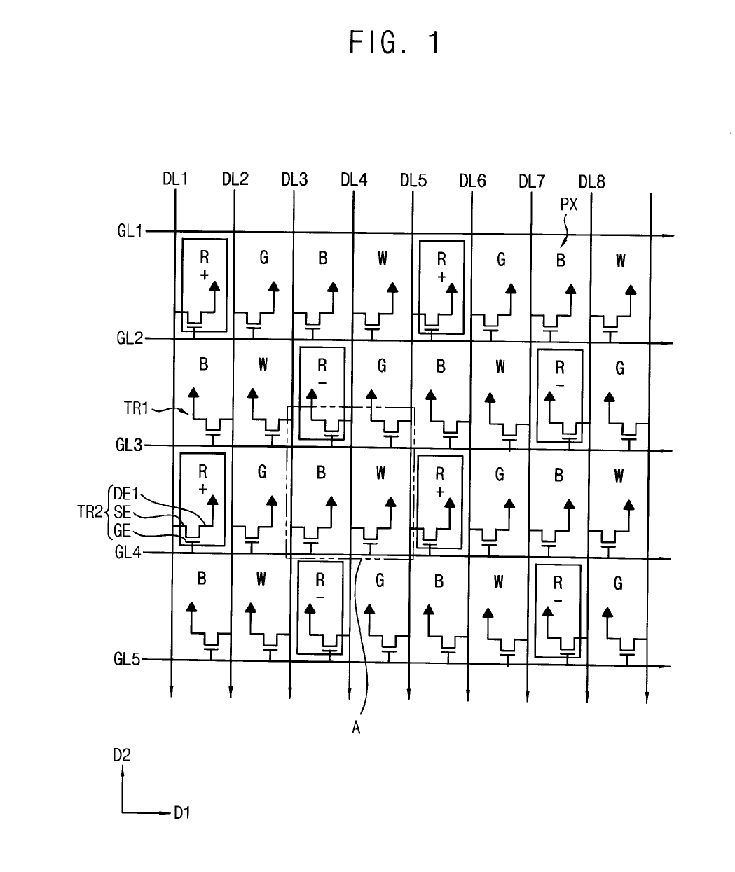

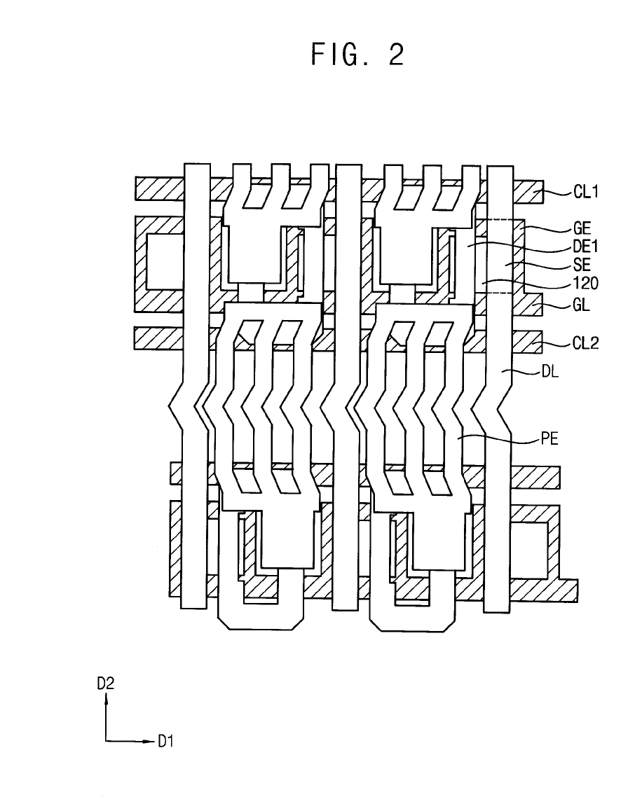

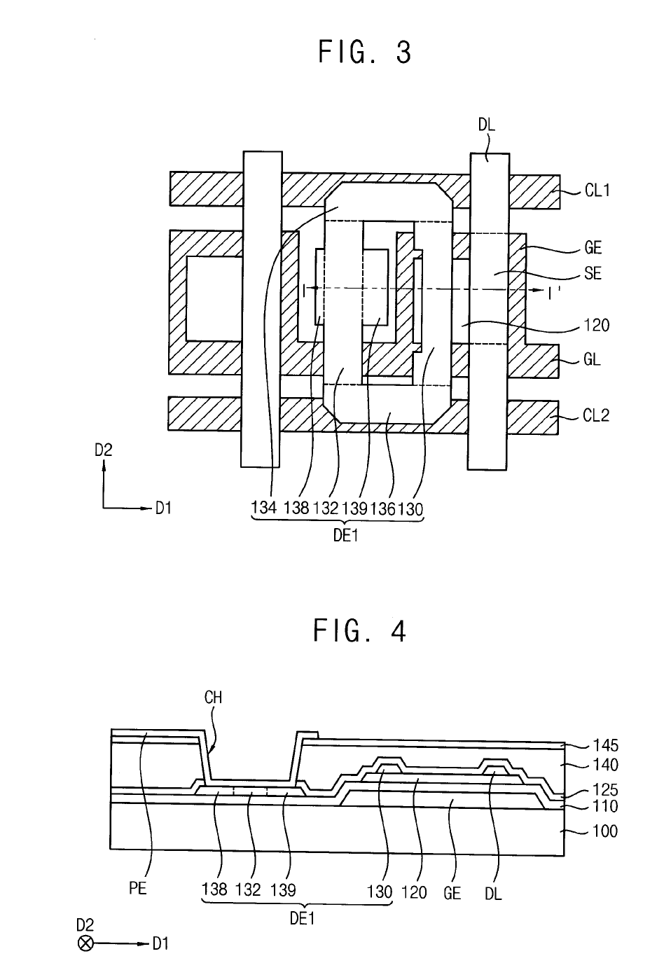

FIG. 1 is a schematic diagram illustrating an electrical structure of a display substrate, according to exemplary embodiments. FIG. 2 is a plan view of region A of FIG. 1, according to exemplary embodiments. FIG. 3 is an enlarged plan view of FIG. 2, according to exemplary embodiments. FIG. 4 is a cross-sectional view taken along line I-I′ of FIG. 3, according to exemplary embodiments.

Referring to FIG. 1, the display substrate may include a plurality of gate lines GL1 to GLn, a plurality of data lines DL1 to DLm, a plurality of switching devices TR1 and TR2, and a plurality of pixels PX disposed on a first base substrate. To avoid obscuring exemplary embodiments, FIG. 1 merely depicts those pixels PX disposed in connections with gate lines GL1 to GL5 and data lines DL1 to DL8, which are illustrative of the plurality of pixels PX of the display substrate. Further, it is noted that “n” and “m” are natural numbers greater than zero, which may be the same as or different from one another.

The plurality of gate lines GL1 to GLn may extend in a first direction D1, and each of the gate lines GL1 to GLn may be spaced apart from each other in a second direction D2, which may be perpendicular (or substantially perpendicular) to the first direction D1. Further, the plurality of gate lines GL1 to GLn may include odd gate lines GL1, GL3, GL5, . . . , and GLn-1, and even gate lines GL2, GL4, . . . , and GLn, which may be disposed in an alternating fashion. The plurality of data lines DL1 to DLm may extend in the second direction D2, and each of the data lines DL1 to DLm may be spaced apart from each other in the first direction D1. Further, the plurality of data lines DL1 to DLm may include odd data lines DL1, DL3, . . . , and DLn-1 and even data lines DL2, DL4, . . . , and DLm, which may be disposed in an alternating fashion.

Each of the switching devices TR1 and TR2 may be disposed at an intersection of a corresponding gate line of the plurality of gate lines GL1 to GLn and a corresponding data line of the plurality of data lines DL1 to DLm. The plurality of switching devices TR1 and TR2 may include odd switching devices TR1, which may be electrically connected to an odd gate line (e.g., gate line GL1), and even switching devices TR2, which may be electrically connected to an even gate line (e.g., gate line GL2).

In exemplary embodiments, the odd switching devices TR1 and the even switching devices may be disposed inversely from one another with respect to the first direction D1. That is, the odd switching devices TR1 may be electrically connected to the data lines DL1 to DLm that may be disposed on a first (e.g., right) side thereof, and the even switching devices TR2 may be electrically connected to the data lines DL1 to DLm that may be disposed on a second (e.g., “left”) side thereof. As such, the odd switching devices TR1 and the even switching devices TR2 may be disposed in a staggered pattern with respect to the second direction. For instance, rows of odd switching devices TR1 may alternative with rows of even switching devices TR2, such that each column of switching devices may include alternating ones of the odd switching devices TR1 and the even switching devices TR2.

The arrangement of the plurality of gate lines GL1 to GLn, the plurality of data is lines DL1 to DLm, and the plurality of switching devices TR1 and TR2 may reduce or alleviate misalignment issues, as well as reduce or alleviate display quality issues associated therewith. That is, the odd switching devices TR1 and the even switching devices TR2 may be disposed inversely from one another in the first direction D1 and in an alternating fashion in the second direction D2, such that a deviation in an odd switching device TR1 caused by a misalignment may be offset by a deviation in an even switching devices TR2 caused by a misalignment.

According to exemplary embodiments, the plurality of pixels PX may be defined as a region determined by the intersections of the plurality of gate lines GL1 to GLn and the plurality of data lines DL1 to DLn. Each of the pixels PX may be independently operated by each of the switching devices TR1 and TR2. Further, each of the pixels PX may emit a light having a different wavelength. For example, each of the pixels PX may emit red (R) light, green (G) light, blue (B) light, cyan (C) light, yellow (Y) light, magenta (M) light, white (W) light, or any other suitable color. In exemplary embodiments, the display substrate may include even numbers of pixels PX configured to emit red (R) light, green (G) light, blue (B) light, and white (W) light, which is illustrated in FIG. 1. It is contemplated, however, that any other suitable arrangement of pixels PX and emitted colors of light may be utilized in association with exemplary embodiments described herein.

In exemplary embodiments, different pixels PX may be disposed in the second direction D2. That is, the red (R) pixel, the green (G) pixel, the blue (B) pixel, and the white (W) pixel may be disposed in alternating and repeating fashions in the second direction D2, as can be seen in FIG. 1. For example, the red (R) pixel and the blue (B) pixel may be disposed in an alternating and repeating fashion in the second direction D2 as a first column of pixels PX, and the green (G) pixel and the white (W) pixel may be disposed in an alternating and repeating is fashion in the second direction D2 as a second column of pixels PX. The first and second columns of pixels PX may be disposed in an alternating and repeating fashion in the first direction D1. It is noted, however, that the first and second columns of pixels PX may be offset from one another, such that rows of the pixels PX include alternating and repeating arrangements of red (R), green (G), blue (B), and white (W) pixels PX, as illustrated in FIG. 1. In this manner, a red (R) pixel in one column may be electrically connected to an even switching device TR2, and a red (R) pixel in another column may be electrically connected to an odd switching device TR1. The same may also be true for the green (G) pixels, the blue (B) pixels, and the white (W) pixels. As such, a deviation in a red (R), green (G), blue (B), or white (W) pixel at one column may not be offset by a deviation in a corresponding red (R), green (G), blue (B), or white (W) pixel in the same column, but may be offset by a deviation in a corresponding red (R), green (G), blue (B), or white (W) pixel in a different column.

Referring to FIGS. 2 to 4, the display substrate may include a first base substrate 100, the plurality of gate lines GL1 to GLn (which may be collectively or individually referred to hereinafter as gate line(s) GL), the plurality of data lines DL1 to DLm (which may be collectively or individually referred to hereinafter as data line(s) DL), a plurality of common voltage lines CL1 and CL2, a plurality of thin film transistors, and the like. Further, individual thin film transistors may include a gate electrode GE, an active pattern 120, a source electrode SE, a drain electrode DE1, and a pixel electrode PE.

As mentioned above, the gate line GL extends in a first direction D1 on the base substrate 100. The gate electrode GE may be electrically connected to the gate line GL. For example, the gate electrode GE may protrude from (or otherwise be an extension of) the gate line GL in the second direction D2.

The plurality of common voltage lines CL1 and CL2 may be disposed on the first base substrate 100 adjacent to the gate line GL and the gate electrode GE. For instance, a first common voltage line CL1 and a second common voltage line CL2 may be disposed on either lateral sides of a corresponding gate line GL. For example, the first common voltage line CL1 may be disposed more adjacent to the gate electrode GE than the gate line GL, and the second common voltage line CL2 may be disposed more adjacent to the gate line GL than the gate electrode GE. In other words, the gate electrode GE may be disposed between the first common voltage line CL1 and the gate line GL, whereas the gate line GL may be disposed between the gate electrode GE and the second common voltage line CL2. Further, each of the first common voltage line CL1 and the second common voltage line CL2 may extend in the first direction D1, and may constitute a part (or component) of a storage capacitor. In exemplary embodiments, the first common voltage line CL1 and the second common voltage line CL2 may have the same width in the second direction D2. Further, the widths of the first common voltage line CL1 and the second common voltage line CL2 may be substantially the same as a width of the gate line GL in the second direction D2. Also, a first distance between the second common voltage line CL2 and the gate line GL may be substantially the same as a second distance between the first common voltage line CL1 and the gate electrode GE.

A gate insulation layer 110 may be disposed on the first base substrate 100 to cover the gate line GL, the gate electrode GE, the first common voltage line CL1, and the second common voltage line CL2. For example, the gate insulation layer 110 may include (or otherwise be formed of) any suitable material, such as, for instance, silicon oxide, e.g., borophosphosilicate glass (BPSG), tonen silazene (TOSZ), undoped silicate glass (USG), spin on glass (SOG), flowable oxide (FOX), tetraethyl orthosilicate (TEOS), high density plasma chemical vapor is deposition (HDP-CVD) of a silicon-based dielectric film material, etc. It is also contemplated that the gate insulation layer 110 may have a multilayer structure including, for instance, silicon oxide and silicon nitride. Again, however, any suitable insulation material may be utilized.

The active pattern 120 may be disposed on the gate insulation layer 110 to overlap at least a portion of the gate electrode GE. In exemplary embodiments, the active pattern 120 may include any suitable semiconductor material, such as, for instance, amorphous silicon, polysilicon, doped silicon, doped polysilicon, partially crystallized silicon, etc. It is also contemplated that the active pattern 120 may include an oxide semiconductor. That is, the active pattern 120 may include, for example, an oxide of indium, zinc, gallium, tin, hafnium, etc. For instance, the active pattern 120 may include indium-zinc-tin oxide (IZTO), indium-gallium-zinc oxide (IGZO), hafnium-indium-zinc oxide (HIZO), and the like.

As mentioned above, the data line DL may extend in the second direction D2 and may be disposed on the gate insulation layer 110. In this manner, the data line DL may cross the gate line GL, but may be insulated from the gate line GL. Further, the source electrode SE may be a portion of the data line DL where the active pattern 120 and the data line DL overlap one another. The source electrode SE and the active pattern 120 may be disposed in a staggered pattern or arrangement. That is, the source electrode SE at an upper portion of FIG. 2 may overlap a right side portion of the active pattern 120, whereas the source electrode SE at a lower portion of FIG. 2 may overlap a left side portion of the active pattern 120. In this manner, some thin film transistors at the upper portion of FIG. 2 and other thin film transistors at the lower portion of FIG. 2 may be disposed inversely form one another in the first direction D1, as was previously described in association with FIG. 1.

The drain electrode DE1 may be disposed on the gate insulation layer 110. The is drain electrode DE1 may overlap at least a portion of the active pattern 120 and may be spaced apart from the source electrode SE in the first direction D1. The drain electrode DE1 has a ring (or annulus) shaped configuration. In exemplary embodiments, the drain electrode DE 1 may have a first extension portion 130, a second extension portion 132, a first connection portion 134, a second connection portion 136, a first protrusion portion 138, and a second protrusion portion 139. Each of the first extension portion 130 and the second extension portion 132 may extend in the second direction D2. The first extension portion 130 and the second extension portion 132 may be spaced apart from each other in the first direction D1. It is noted that the first extension portion 130 may include a notch between the first connection portion 134 and the second connection portion 136. The notch may open to an interior region of the drain electrode DE1. In this manner, the first extension portion 130 may be disposed to overlap the active pattern 120, and the second extension portion 130 may be disposed not to overlap the active pattern 120.

As seen in FIGS. 3 and 4, the first connection portion 134 and the second connection portion 136 may connect (or otherwise extend from) end portions of the first extension portion 130 and the second extension portion 132. Further, the first connection portion 134 and the second connection portion 136 may be spaced apart from each other in the second direction D2 and extend in the first direction D1. In exemplary embodiments, a distance between the first connection portion 134 and the second connection portion 136 in the second direction D2 may be larger than a sum of a width of the gate electrode GE in the second direction D2 and a width of the gate line GL in the second direction D2. In this manner, the first connection portion 134 and the second connection portion 136 may not overlap the gate electrode GE or the gate line GL.

According to exemplary embodiments, the first protrusion portion 138 and the second protrusion portion 139 may projection from the second extension portion 132 in the first direction D1. In exemplary embodiments, the first protrusion portion 138 and the second protrusion portion 139 may be disposed on either lateral sides of the second extension portion 132, such that the first protrusion portion 138 and the second protrusion portion 139 may form a square shape or a rectangular shape. The first protrusion portion 138 and the second protrusion portion 139 may provide an area at which the drain electrode DE1 is electrically connected to the pixel electrode PE.

A first passivation layer 125 may be disposed on the gate insulation layer 110 to cover the active pattern 120, the data line DL, the source electrode SE, and the drain electrode DE1. In exemplary embodiments, the first passivation layer 125 may include any suitable insulation material, such as, for example, silicon oxide, silicon nitride, etc. A planarization layer 140 may be disposed on the first passivation layer 125 to provide a top surface that may be flat (or substantially flat). For example, the planarization layer 140 may include an organic insulation material. Further, a second passivation layer 145 may be disposed on the planarization layer 140. It is contemplated, however, that one or more of the first passivation layer 125, the planarization layer 140, and the second passivation layer 145 may be contiguously formed. For instance, the first passivation layer 125, the planarization layer 140, and the second passivation layer 145 may be one contiguous formation (or layer) of the same material.

As seen in FIG. 4, the pixel electrode PE may be electrically connected to the drain electrode DE1. That is, the pixel electrode PE may contact the drain electrode DE1 through a contact hole CH penetrating (or otherwise extending through) the first passivation layer 125, the planarization layer 140, and the second passivation layer 145. In exemplary embodiments, the pixel electrode PE may include any suitable transparent conductive material, such as, for example, aluminum zinc oxide (AZO), gallium zinc oxide (GZO), indium tin oxide (ITO), indium zinc oxide (IZO), etc. It is also contemplated that one or more conductive polymers (ICP) may be utilized, such as, for example, polyaniline, poly(3,4-ethylenedioxythiophene) poly(styrenesulfonate) (PEDOT:PSS), etc. In exemplary embodiments, the pixel electrode PE may include a plurality of slits that may be inclined in one or more different directions, such as seen in FIG. 2. In this manner, when a voltage is applied to the pixel electrode PE, an electrical field may be generated in the different directions in the same pixel PX, such that liquid crystal molecules of a liquid crystal layer (not shown) may rotate with respect to the different directions of the slits. As such, anisotropy of a refractive index of the liquid crystal molecules may be compensated, such that color shifting issues may be reduced or prevented.

An exemplary operation of a display device including the display substrate of FIGS. 1-4 will be described below.

Each of the pixels PX may be electrically connected to at least one gate line GL and at least one data line DL. Each of the pixels PX may include a corresponding thin film transistor TR (e.g., one of the first switching device TR1 or the second switching device TR2) and a respective storage capacitor SC. As previously mentioned, a storage capacitor SC may be formed with respect to the first common voltage line CL1 and the second common voltage line CL2. The thin film transistor TR may be disposed at an intersection of a gate line GL and a data line DL. The thin film transistor TR may include a gate electrode GE electrically connected to the gate line GL, a source electrode SE electrically connected to the data line DL, and a drain electrode DE1. The storage capacitor SC may be disposed where the first common voltage line CL1 and the second common voltage line CL2 and the pixel electrode PE overlap one another. Further, the drain electrode DE1 and the common electrode (not illustrated) may constitute a liquid crystal capacitor LC.

In operation of the display device, a gate voltage may be applied to the gate electrode GE of the thin film transistor TR, and a data voltage may be applied to the source electrode SE of the thin film transistor TR. When the gate voltage is higher than a threshold voltage of the thin film transistor TR, a channel may be formed between the source electrode SE and the drain electrode DE1, and a voltage may be applied to the storage capacitor SC and the liquid crystal capacitor LC through the source electrode SE, the drain electrode DE1, and the pixel electrode PE. In this manner, a kick back voltage Vkb may be defined as a difference between the data voltage and the voltage of the liquid crystal capacitor LC. The kick back voltage Vkb may be an inevitable factor when the drain electrode DE1 or the source electrode SE overlaps the gate electrode GE. The kick back voltage Vkb may be represented as provided in Equation (1), shown below:

Vkb=Cgs*ΔVg/(Cgs+Clc+Cst) Eq. (1)

Where ΔVg represents a difference between a high value (Vgh) and a low value (Vgl) of the gate voltage, Clc represents a liquid crystal capacitance, Cst represents a storage capacitance, and Cgs represents a parasitic capacitance between the gate electrode GE and the source electrode SE or the drain electrode DE1.

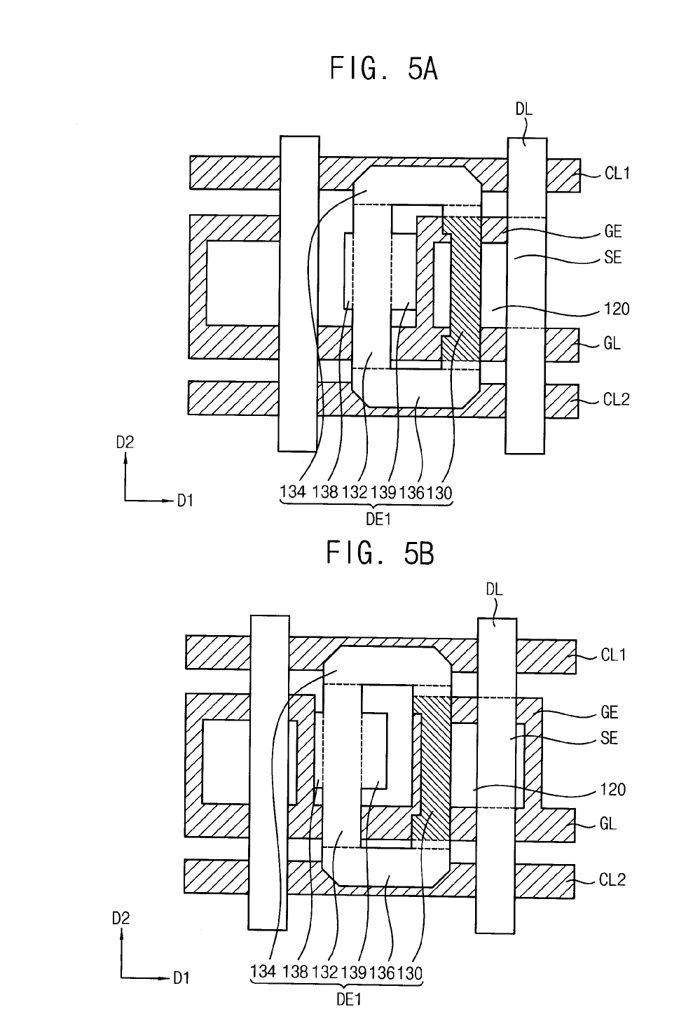

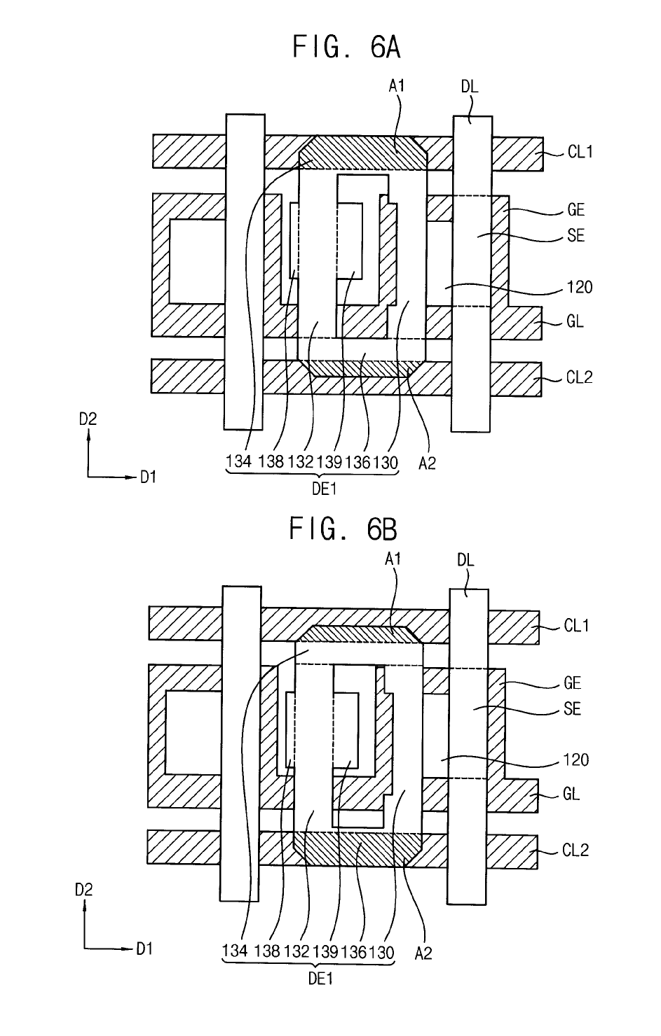

It is noted that when the kick back voltage Vkb increases, display quality issues may arise, such as a flicker, an afterimage, etc. For instance, when the gate electrode GE is misaligned with the source electrode SE or the drain electrode DE1, the kick back voltage Vkb deviation may increase, which may increase the presence of display quality issues. The display substrate, according to exemplary embodiments, however, is configured such that, even though is the gate electrode GE, the source electrode SE, and/or the drain electrode DE1 may be misaligned in the first direction D1 or the second direction D2, the kick back voltage Vkb deviation may not increase due to the aforementioned inverse dispositions of the first switching device TR1 and the second switching device TR2. The effect of the display substrate, according to exemplary embodiments, is described with reference to FIGS. 5A, 5B, 6A, and 6b.

FIGS. 5A and 5B are respective plan views illustrating a change in overlapped area between a drain electrode and a gate electrode, according to exemplary embodiments. That is, FIG. 5A illustrates the drain electrode DE1 and the source electrode SE being shifted in the first direction D1, as compared to a normal, non-shifted position, whereas FIG. 5B illustrates the drain electrode DE1 and the source electrode SE being shifted in a direction opposite the first direction D1, as compared to a normal, non-shifted position.

Referring to FIGS. 5A and 5B, the first extension portion 130 of the drain electrode DE1 overlaps the gate electrode GE. It is noted, however, that the second extension portion 132, the first connection portion 134, and the second connection portion 136 of the drain electrode DE1 may not overlap the gate electrode GE. Even though, the drain electrode DE1 is shifted in the first direction D1 or a direction opposite the first direction D1, an overlapped area between the drain electrode DE1 and the gate electrode GE may remain constant. As such, a parasitic capacitance Cgs between the gate electrode GE and the source electrode SE or the drain electrode DE1 may also remain constant. Accordingly, the kick back voltage Vkb deviation may not increase even though the drain electrode DE1 is misaligned in the first direction D1 or the direction opposite the first direction D1.

FIGS. 6A and 6B are respective plan views illustrating a change in overlapped area between a drain electrode and a gate electrode, according to exemplary embodiments. That is, FIG. 6A illustrates the drain electrode DE1 and the source electrode SE being shifted in the second direction D2 as compared to a normal, non-shifted position, whereas FIG. 6B illustrates the drain electrode DE1 and the source electrode SE being shifted in a direction opposite to the second direction D2 as compared to a normal, non-shifted position.

Referring to FIGS. 6A and 6B, the first connection portion 134 and the second connection portion 136 of the drain electrode DE1 overlap the first common voltage line CL1 and the second common voltage line CL2, respectively. In this manner, a first area A1 may be defined as an overlapped area between the first connection portion 134 and the first common voltage line CL1, and a second area A2 may be defined as an overlapped area between the second connection portion 136 and the second common voltage line CL2. The sum of the first area A1 and the second area A2 may be constant. That is, when the drain electrode DE1 shifts in the second direction D2, the first area A1 may increase and the second area A2 may decrease. When, however, the drain electrode DE1 shifts in a direction opposite the second direction D2, the first area A1 may decrease and the second area A2 may increase. As such, the sum of the first area A1 and the second area A2 may remain constant despite a shift.

According to exemplary embodiments, the drain electrode DE1 may be electrically connected to the pixel electrode PE, such that the sum of the first area A1 and the second area A2 may affect the storage capacitance Cst between the pixel electrode PE and the first and second common voltage lines CL1 and CL2. As such, the sum of the first area A1 and the second area A2 may remain constant, which may enable the storage capacitance Cst to also remain constant. In this manner, the kick back voltage Vkb deviation may not increase even though the drain electrode DE1 is misaligned in the second direction D2 or the direction opposite the second direction D2.

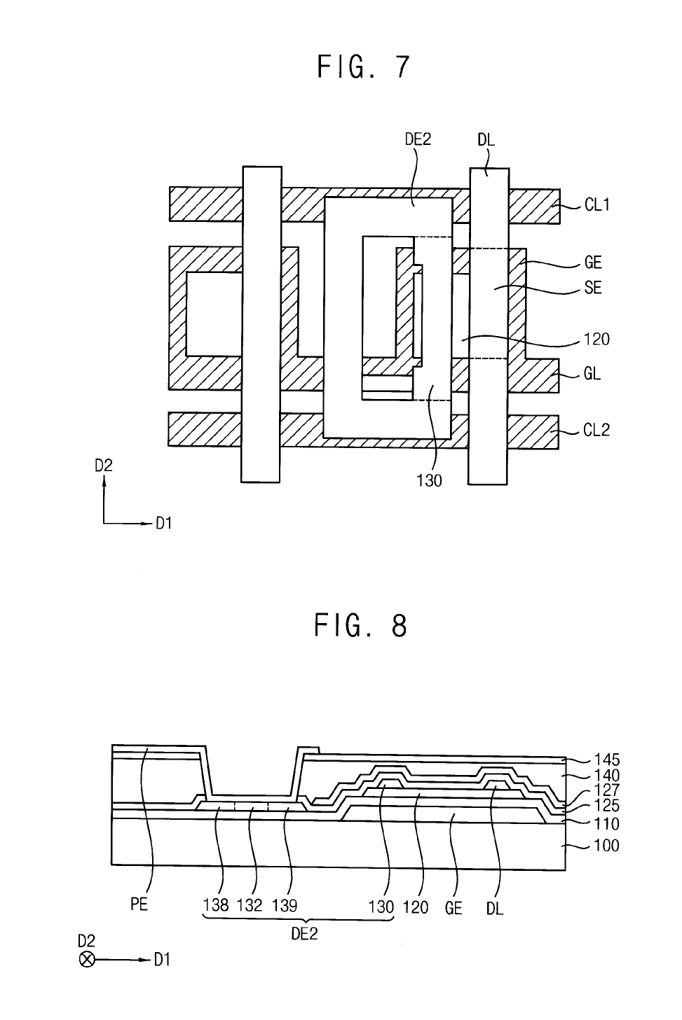

FIG. 7 is an enlarged plan view illustrating a display substrate, according to exemplary embodiments. The display substrate of FIG. 7 may be substantially similar to the display substrate of FIGS. 1 to 6, except for the shape of a drain electrode DE2. As such, to avoid obscuring exemplary embodiments described herein, the configuration and disposition of the drain electrode DE2 is described with respect to one or more other components of the display substrate.

According to exemplary embodiments, the drain electrode DE2 may have a rectangular shape in which the center is empty. That is, the drain electrode DE2 may form a rectangular annulus. To this end, a portion of the rectangular shape overlapping the gate line GL and the gate electrode GE (e.g., the first extension portion 130) may be notched. For instance, the notch may open to the voided interior region of the rectangular shape of the drain electrode DE2. According to exemplary embodiments, the kick back voltage Vkb deviation may not increase even though the drain electrode DE2 is misaligned in the first direction D1 or the second direction D2.

FIG. 8 is a cross sectional view illustrating a display substrate, according to exemplary embodiments. The display substrate of FIG. 8 may be substantially similar to the display substrate of FIGS. 1 to 6 except for the inclusion of a common voltage layer 127. As such, to avoid obscuring exemplary embodiments described herein, the configuration and disposition of the common voltage layer 127 is described with respect to one or more other components of the display substrate.

According to exemplary embodiments, the common voltage layer 127 may be disposed between the first passivation layer 125 and the planarization layer 140. The common voltage layer 127 may include any suitable conductive material, such as one or more of the is conductive materials utilized to form the pixel electrode PE. The common voltage layer 127 may be electrically isolated from the pixel electrode PE and the drain electrode DE2. In exemplary embodiments, the common voltage layer 127 may be disposed to overlap at least a portion of the thin film transistor TR. The common voltage layer 127 and the pixel electrode PE may constitute a storage capacitor. The common voltage layer 127 may have a relatively large area, such that the storage capacitor may have a sufficient capacitance.

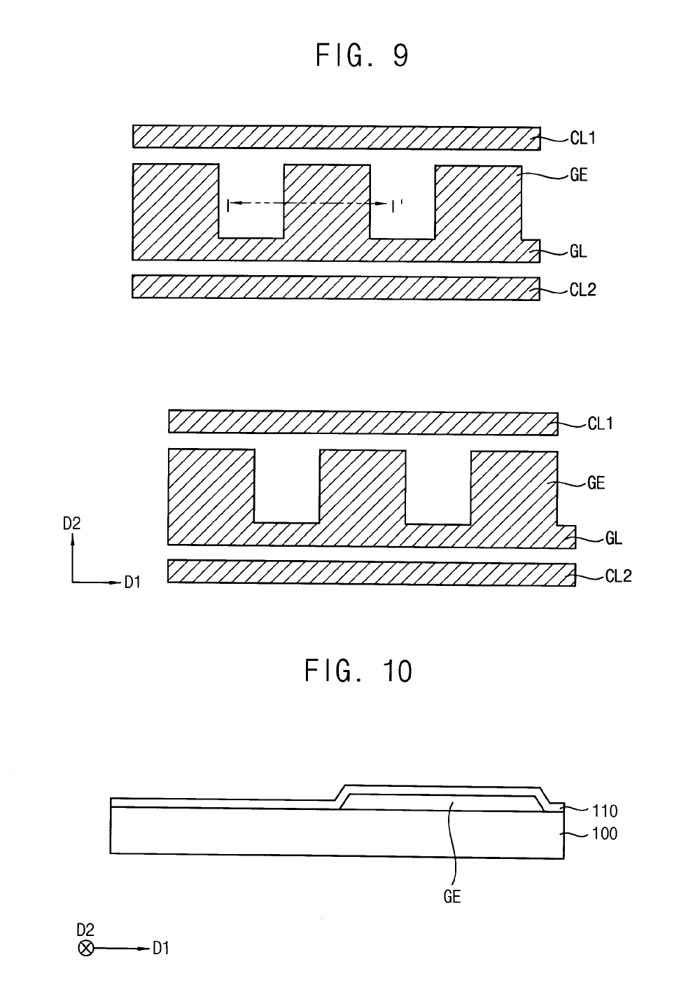

FIGS. 9 to 17 are plan views and cross-sectional views illustrating a method of manufacturing a display substrate, according to exemplary embodiments. That is, FIGS. 9, 11, 13, and 16 are respective plan views of the display substrate at various stages of manufacture, whereas FIGS. 10, 12, 14, 15, and 17 are respective cross-sectional views of the display substrate at the various stages of manufacture taken along sectional line I-I′ of a corresponding plan view.

Referring to FIGS. 9 and 10, a gate line GL, a gate electrode GE, the first common voltage line CL1, and the second common voltage line CL2 are formed on a first base substrate 100. That is, a first conductive layer may be formed on the first base substrate 100, and the first conductive layer may be patterned to form the gate line GL, the gate electrode GE, the first common voltage line CL1, and the second common voltage line CL2.

The gate line GL may extend in the first direction D1 as illustrated in FIG. 1. In exemplary embodiments, a plurality of gate lines GL may be spaced apart from each other in the second direction D2. The gate electrode GE is electrically connected to the gate line GL. For example, the gate electrode GE may protrude (or otherwise extend) from the gate line GL in the second direction D2. That is, the gate electrode GE and the gate line GL may be integrally (or contiguously) formed.

In exemplary embodiments, a plurality of common voltage lines CL1 and CL2 is may be disposed on the first base substrate 100 adjacent to the gate line GL and the gate electrode GE. That is, a first common voltage line CL1 and a second common voltage line CL2 may be disposed on either lateral sides of a corresponding gate line GL. For example, the first common voltage line CL1 may be disposed more adjacent to the gate electrode GE than the gate line GL, and the second common voltage line CL2 may be disposed more adjacent to the gate line GL than the gate electrode GE. Further, each of the first common voltage line CL1 and the second common voltage line CL2 may extend in the first direction D1. It is noted that the first common voltage line CL1 and the second common voltage line CL2 may have the same width in the second direction D2. Further, the widths of the first common voltage line CL1 and the second common voltage line CL2 may be substantially the same as a width of the gate line GL in the second direction D2. Also, a first distance between the second common voltage line CL2 and the gate line GL may be substantially the same as a second distance between the first common voltage line CL1 and the gate electrode GE.

According to exemplary embodiments, the first base substrate 100 may be formed of any suitable material, such as, for example, a glass substrate, a quartz substrate, a silicon substrate, a plastic substrate, and the like. Examples of a material that may be used for the first conductive layer may include copper, silver, chromium, molybdenum, aluminum, titanium, manganese, etc., or an alloy of one or more of the materials. The first conductive layer may have a single-layered structure or a multi-layered structure including a plurality of metal layers of different metals.

A gate insulation layer 110 may be formed on the first base substrate 100 to cover the gate line GL, the gate electrode GE, the first common voltage line CL1, and the second common voltage line CL2. The gate insulation layer 110 may be formed by a coating process, a is chemical vapor deposition (CVD) process, an atomic layer deposition (ALD) process, or any other suitable process. For example, the gate insulation layer 110 may include silicon oxide, such as, for instance, borophosphosilicate glass (BPSG), tonen silazene (TOSZ), undoped silicate glass (USG), spin on glass (SOG), flowable oxide (FOX), tetraethyl orthosilicate (TEOS), a high density plasma chemical vapor deposition (HDP-CVD) silicon-based material, etc. It is also contemplated that the gate insulation layer 110 may have a multilayer structure including silicon oxide and silicon nitride.

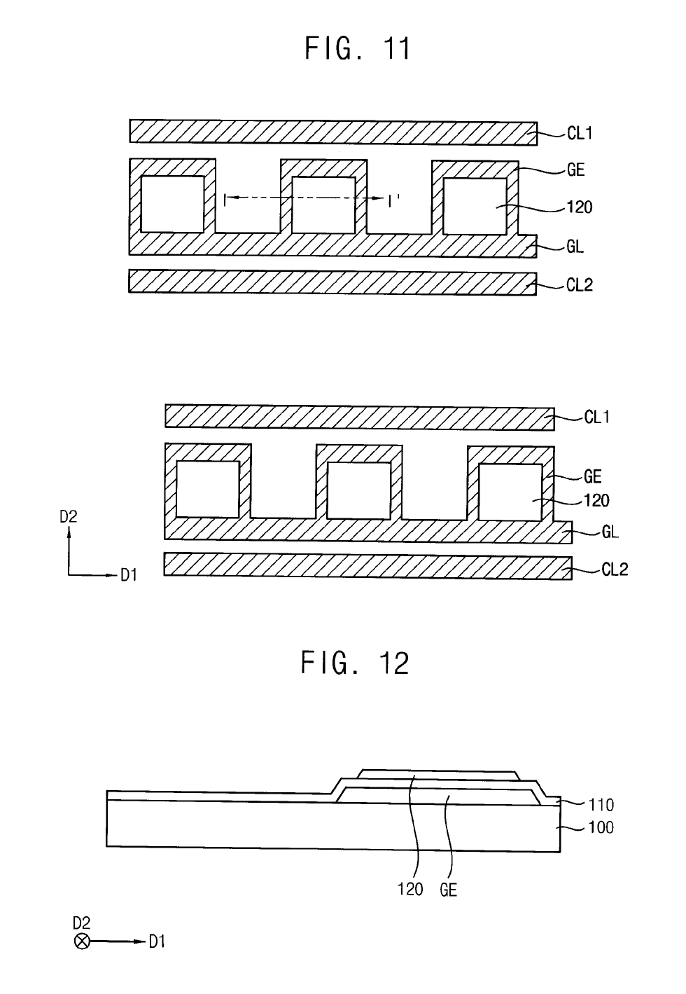

Referring to FIGS. 11 and 12, an active pattern 120 may be formed on the gate insulation layer 110 to overlap at least a portion of the gate electrode GE. That is, any suitable semiconductor material may be formed as a layer on at least a portion of the gate insulation layer 110. The semiconductor layer may be patterned to form the active pattern 120. The active pattern 120 may be formed to overlap at least a portion of the gate electrode GE.

In exemplary embodiments, the semiconductor layer may be formed using amorphous silicon, doped amorphous silicon, etc. In this manner, the semiconductor layer may be formed using a CVD process, a plasma enhanced CVD process, a low pressure CVD process, a sputtering process, or any other suitable process. A crystallization process may be performed on the semiconductor layer. The crystallization process may include a laser induced crystallization process, a thermal induced crystallization process, a thermal induced crystallization process using a catalyst, etc. As such, the active pattern 120 may include polysilicon, doped polysilicon, etc.

It is also contemplated that the semiconductor layer may be formed using any suitable oxide semiconductor. That is, the oxide semiconductor may include, for instance, an oxide of indium, zinc, gallium, tin, hafnium, etc. For example, the oxide semiconductor may include indium-zinc-tin oxide (“IZTO”), indium-gallium-zinc oxide (“IGZO”), hafnium-indium-zinc oxide (“HIZO”), etc. Further, an annealing process may be performed to heat the oxide semiconductor layer. For example, the annealing process may be performed at a temperature of about 230° C. to about 400° C. The annealing process may improve the electrical characteristics of the oxide semiconductor layer.

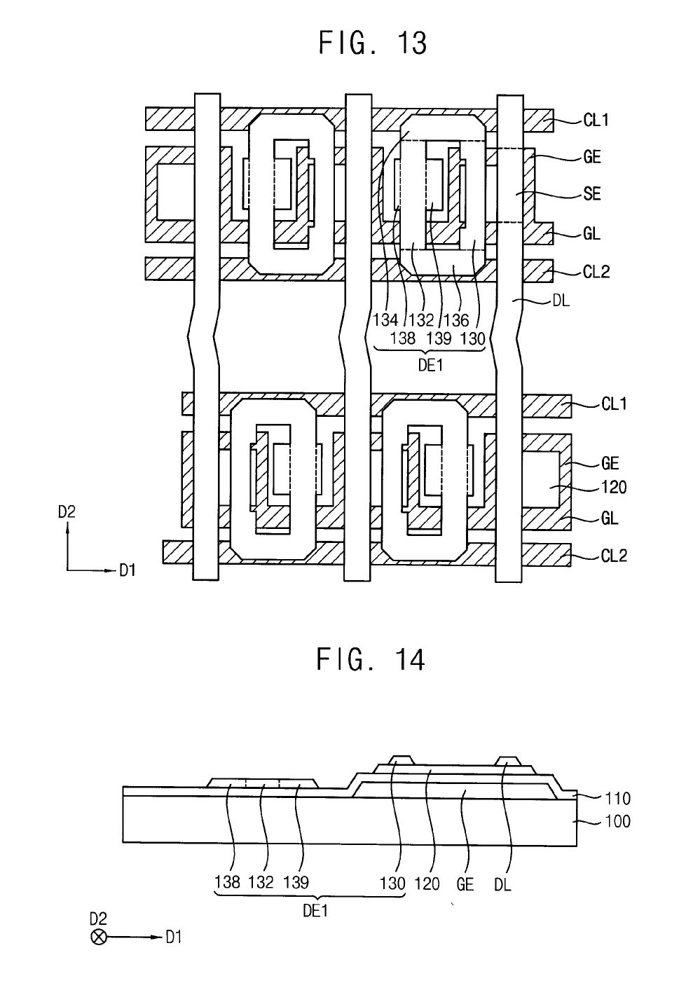

Referring to FIGS. 13 and 14, a data line DL, a source electrode SE, and a drain electrode DE1 may be formed. That is, a second conductive layer may be formed on the gate insulation layer 110 and the active pattern 120. The second conductive layer may be patterned to form the data line DL, the source electrode SE, and the drain electrode DE1. The data line DL may extend in the second direction D2. In exemplary embodiments, a plurality of data lines DL may be spaced apart from each other in the first direction D1. The source electrode SE may be defined as a portion of the data line DL where the active pattern 120 and the data line DL overlap one another. That is, the source electrode SE and the data line DL may be integrally formed with one another. It is also contemplated that the source electrode SE may protrude (or otherwise extend) from the data line DL in the first direction D1. In this manner, the source electrode SE and the data line DL may be integrally formed.

According to exemplary embodiments, the source electrode SE and the active pattern 120 may be disposed in a staggered pattern. That is, the source electrode SE at an upper portion of FIG. 13 may overlap a right side portion of the active pattern 120, whereas the source electrode SE at a lower portion of FIG. 13 may overlap a left side portion of the active pattern 120. As such, some thin film transistors at the upper portion of FIG. 13 and other thin film transistors at the lower portion of FIG. 13 may be disposed inversely in the first direction D1, as previously described in association with FIG. 1. The arrangement of the thin film transistors may offset a deviation due to a misalignment of the drain electrodes of the various thin film transistors.

In exemplary embodiments, the drain electrode DE1 may be disposed on the gate insulation layer 110. The drain electrode DE1 may overlap at least a portion of the active pattern 120 and may be spaced apart from the source electrode SE in the first direction D1. The drain electrode DE1 may have a ring (or annulus) shape. In exemplary embodiments, the drain electrode DE 1 may have a first extension portion 130, a second extension portion 132, a first connection portion 134, a second connection portion 136, a first protrusion portion 138, and a second protrusion portion 139.

As seen in FIG. 13, the first extension portion 130 may be disposed to overlap at least a portion of the active pattern 120, and the second extension portion 130 may be disposed not to overlap the active pattern 120. The drain electrode DE1 may have a shape wherein a center is empty, such that the overlapped area between the drain electrode DE1 and the gate electrode GE may not change despite shifts in the position of the drain electrode DE1 with respect to one or more other components of the display substrate. To this end, a portion of the first extension portion 130 may be notched between the first connection portion 134 and the second connection portion 136. The notch may open to an interior region of the ring shaped drain electrode DE1.

According to exemplary embodiments, the first connection portion 134 and the second connection portion 136 may extend in the first direction D1 and may be spaced apart from each other in the second direction D2. The first connection portion 134 and the second connection portion 136 of the drain electrode DE1 overlap portions of the first common voltage line CL1 and the second common voltage line CL2, respectively. In this manner, a first area A1 is may be defined as an overlapped area between the first connection portion 134 and the first common voltage line CL1, and a second area A2 may be defined as an overlapped area between the second connection portion 136 and the second common voltage line CL2. When the drain electrode DE1 is shifted in the second direction D2, the first area A1 may increase and the second area A2 may decrease. When the drain electrode DE1 is shifted in a direction opposite to the second direction D2, the first area A1 may decrease and the second area A2 may increase. In this manner, the sum of the first area A1 and the second area A2 may remain constant. To this end, an electrical characteristic deviation (e.g., the kick back voltage Vkb deviation) of the thin film transistor may not increase even though the drain electrode DE1 may be misaligned in the first direction D1 or the second direction D2.

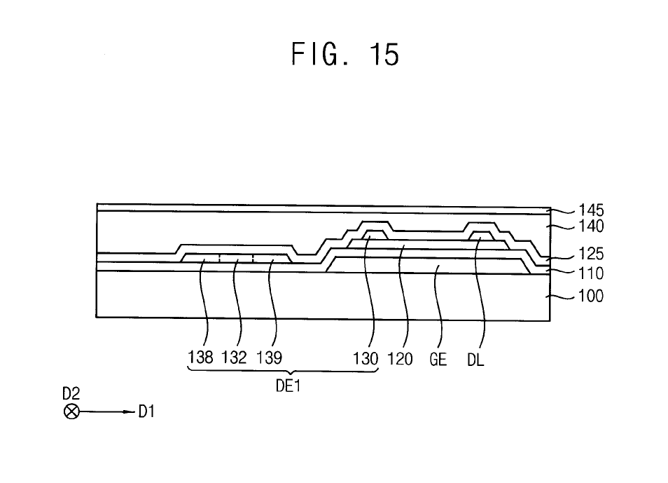

Referring to FIG. 15, a first passivation layer 125, a planarization layer 140, and a second passivation layer 145 may be formed to cover the thin film transistor TR. The first passivation layer 125 and the second passivation layer 145 may be formed using an inorganic material, such as silicon oxide, silicon nitride, etc. Further, the planarization layer 140 may be formed using an organic material by a coating process or a CVD process. In this manner, the planarization layer 140 may have a top surface that may be flat (or substantially flat). Although not illustrated, a common voltage layer may be formed between the first planarization layer 140 and the first passivation layer 125, such as illustrated in FIG. 8.

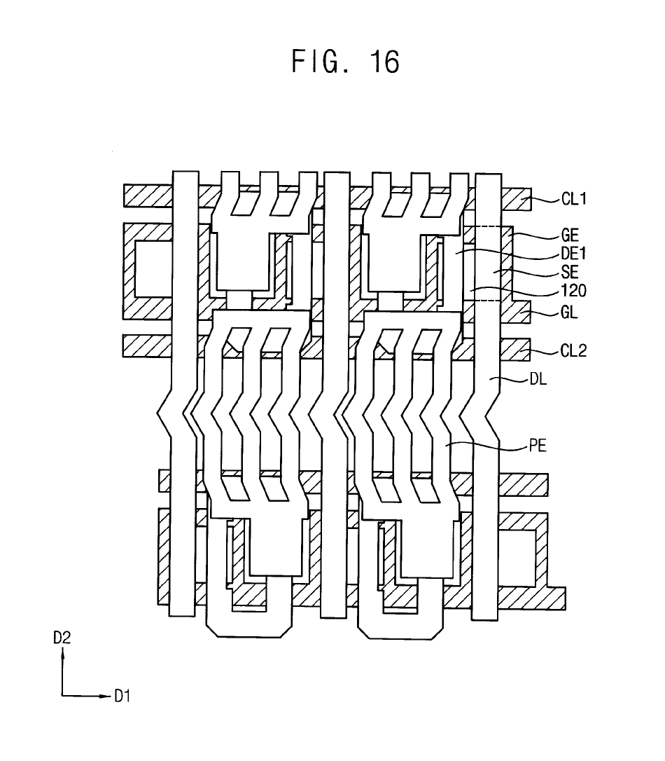

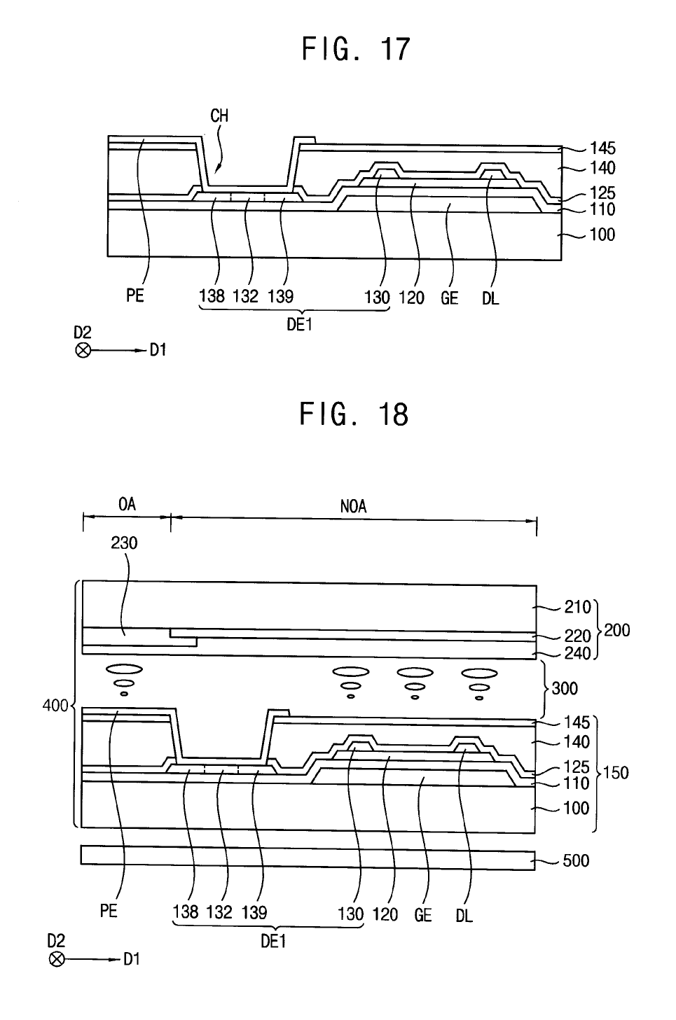

Referring to FIGS. 16 and 17, after forming a contact hole CH, a pixel electrode PE may be formed to be electrically connected to the drain electrode DE1. That is, the first passivation layer 125, the planarization layer 140, and the second passivation layer 145 may be partially removed to form the contact hole CH to expose a portion of the drain electrode DE1. To this end, a transparent conductive layer may be formed on a portion of the second passivation layer 145, an inner wall of the contact hole CH, and the exposed portion of the drain electrode DE1. The transparent conductive layer may be patterned to form the pixel electrode PE. It is noted that the pixel electrode PE may include a transparent conductive material, such as, for example, aluminum zinc oxide (AZO), gallium zinc oxide (GZO), indium tin oxide (ITO) or indium zinc oxide (IZO), etc. It is also contemplated that one or more conductive polymers (ICP) may be utilized, such as, for example, polyaniline, poly(3,4-ethylenedioxythiophene) poly(styrenesulfonate) (PEDOT:PSS), etc.

FIG. 18 is a cross sectional view illustrating a display apparatus, according to exemplary embodiments.

Referring to FIG. 18, the display apparatus may include a liquid crystal display panel 400 and a backlight unit 500. The liquid crystal display panel 400 may include a display substrate 150, an opposite substrate 200, and a liquid crystal layer 300. The liquid crystal display panel 400 has an opening portion OA configured to selectively enable light from the backlight unit 500 to pass therethrough and a non-opening portion NOA configured to block the light from the backlight unit 500 from passing therethrough. The opening portion OA may correspond to a plurality of pixel areas (not shown) disposed in a matrix formation. It is contemplated, however, that any other suitable formation or arrangement may be utilized. The non-opening portion NOA may correspond to boundary portions between the pixel areas.

According to exemplary embodiments, the display substrate 150 may include a thin film transistor TR and a pixel electrode PE electrically connected to the thin film transistor TR. The opposite substrate 200 may face the display substrate 150. The liquid crystal layer 300 may be disposed between the display substrate 150 and the opposite substrate 200. Although the display substrate 150 is illustrated as being disposed under the liquid crystal layer 300, such that is the backlight unit 500 is configured to emit light to the display substrate 150, any other suitable configuration may be utilized. For instance, the display substrate 150 may be disposed on the liquid crystal layer 300, such that the opposite substrate 200 may be disposed under the liquid crystal layer 300 and the backlight unit 500 may emit light to the opposite substrate 200.

It is noted that the display substrate 150 may be substantially similar to the display substrate described with reference to FIGS. 1 to 6. To avoid obscuring exemplary embodiments described herein, a duplicative description has been omitted.

In exemplary embodiments, the opposite substrate 200 may include a second base substrate 210, a light blocking pattern 220, a color filter pattern 230, and a common electrode 240. The second base substrate 210 may include a transparent insulating material. For example, the second base substrate 210 may include a material substantially the same as a material of the first base substrate 100. For instance, the second base substrate 210 may include a glass, a quartz, a plastic, a polyethylene terephthalate resin, a polyethylene resin, a polycarbonate resin, etc., material. That is, any suitable material may be utilized for the second base substrate 210.

The light blocking pattern 220 may be arranged in correspondence with the non-opening portion NOA. The light blocking pattern 220 may be disposed on the second base substrate 210. The light blocking pattern 220 blocks the light at the boundary portion of the pixel areas. For example, the light blocking pattern 220 may overlap a data line DL, a gate line GL, and the thin film transistor TR.

The color filter pattern 230 may be arranged in correspondence with the opening portion OA. The color filter pattern 230 may be disposed on the light blocking pattern 220 and the second base substrate 210. The color filter pattern 230 may partially overlap the light blocking pattern 220. The color filter pattern 230 may include color filters. For example, the is color filter pattern 230 may include a red filter, a green filter, and a blue filter. It is contemplated, however, that any other suitable color filter may be utilized, such as a yellow filter, a magenta filter, a white filter, etc.

The common electrode 240 may be disposed on the color filter pattern 230 and the light blocking patter 220. The common electrode 240 may be formed from any suitable transparent conductive material. For example, the common electrode 240 may include aluminum zinc oxide (AZO), gallium zinc oxide (GZO), indium zinc oxide (IZO), indium tin oxide (ITO), tin oxide (SnOₓ) zinc oxide (ZnOₓ), etc. It is also contemplated that one or more conductive polymers (ICP) may be utilized, such as, for example, polyaniline, poly(3,4-ethylenedioxythiophene) poly(styrenesulfonate) (PEDOT:PSS), etc.

The backlight unit 500 may be disposed under the liquid crystal display panel 400. The backlight unit 500 may provide light to the display substrate 150.

According to exemplary embodiments, the display substrate comprises a thin film transistor including a drain electrode having a ring (or annulus) shape. As such, even though the drain electrode may be shifted with respect to one or more other components of the display substrate, such as shifted in a first direction or a direction opposite the first direction, an overlapped area between the drain electrode and the gate electrode may remain constant. As such, a parasitic capacitance between the drain electrode and the gate electrode may also remain constant despite a shift in the position of the drain electrode. Further, even though the drain electrode may be shifted with respect to one or more other components of the display substrate in a second direction or a direction opposite the second direction, an overlapped area between the drain electrode and the first and second common voltage lines may remain constant. As such, a storage capacitance may also remain constant despite a shift in the position of the drain electrode.

As previously mentioned, although various exemplary embodiments are described with respect to a liquid crystal display implementation, it is contemplated that various exemplary embodiments are also applicable to other display technologies, such as, for example, organic light emitting displays, plasma displays, field emission displays, electrophoretic displays, electrowetting displays, and the like.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display substrate, comprising:
thin film transistors, each thin film transistor comprising a gate electrode, a source electrode, and an annulus-shaped drain electrode;
first common voltage lines disposed adjacent to first sides of the gate electrodes; and
second common voltage lines disposed adjacent to second sides of the gate electrodes.

2. The display substrate of claim 1, wherein:
the annulus-shaped drain electrode comprises a first extension portion, a second extension portion, a first connection portion, and a second connection portion;
the first extension portion and the second extension portion extend in a first direction and are spaced apart from one another in a second direction crossing the first direction; and
the first connection portion and the second connection portion extend in the second direction, connect respective end portions of the first extension portion and the second extension portion, and are spaced apart from one another in the first direction.

3. The display substrate of claim 2, wherein:
the first extension portion at least partially overlaps the gate electrode; and
the second extension portion and the gate electrode do not overlap one another.

4. The display substrate of claim 2, wherein:
the first connection portion at least partially overlaps a corresponding one of the first common voltage lines; and
the second connection portion at least partially overlaps a corresponding one of the second common voltage lines.

5. The display substrate of claim 4, wherein the sum of a first overlapped area between the first connection portion and the first common voltage line and a second overlapped area between the second connection portion and the second common voltage line is substantially constant across the thin film transistors.

6. The display substrate of claim 2, further comprising:
a pixel electrode electrically connected to at least the second extension portion of the annulus-shaped drain electrode.

7. The display substrate of claim 6, wherein the sum of a first capacitance between the drain electrode and the gate electrode and a second capacitance between the drain electrode and the pixel electrode is substantially constant across the thin film transistors.

8. The display substrate of claim 2, wherein a distance between the first connection portion and the second connection portion in the first direction is larger than the width of the gate electrode in the first direction.

9. The display substrate of claim 1, wherein:
the display substrate further comprises odd gate lines and even gate lines, the odd gate lines being electrically connected to gate electrodes of first ones of the thin film transistors and the even gate lines being electrically connected to gate electrodes of second ones of the thin film transistors;
the odd gate lines and the even gate lines are disposed in an alternating arrangement; and
some of the first ones of the thin film transistors are inversely disposed with respect to some of the second ones of the thin film transistors.

10. The display substrate of claim 9, further comprising:
data lines electrically connected to respective ones of the source electrodes; and
pixels arranged in a matrix formation, each pixel comprising a corresponding one of the thin film transistors.

11. The display substrate of claim 10, wherein:
the matrix formation comprises an equivalent number of pixels configured to emit different colors of light; and
pixels configured to emit the same color of light are spaced apart from one another in a first direction and a second direction crossing the first direction.

12. The display substrate of claim 1, wherein:
the respective widths of the first common voltage lines, the second common voltage lines, and the gate electrodes are substantially the same as one another; and
the respective thicknesses of the first common voltage lines, the second common voltage lines, and the gate electrodes are substantially the same as one another.

13. The display substrate of claim 1, further comprising:
a passivation layer disposed on the thin film transistors.

14. The display substrate of claim 13, further comprising:
a common voltage layer disposed on the passivation layer.

15. A display apparatus, comprising:
a first substrate comprising:
thin film transistors, each thin film transistor comprising a gate electrode, a source electrode, and an annulus-shaped drain electrode;
first common voltage lines disposed adjacent to first sides of the gate electrodes; and
second common voltage lines disposed adjacent to second sides of the gate electrodes;
a second substrate facing the first substrate; and
a liquid crystal layer disposed between the first substrate and the second substrate.

16. The display apparatus of claim 15, wherein:
the annulus-shaped drain electrode comprises a first extension portion, a second extension portion, a first connection portion, and a second connection portion;
the first extension portion and the second extension portion extend in a first direction and are spaced apart from one another in a second direction crossing the first direction; and
the first connection portion and the second connection portion extend in the second direction, connect respective end portions of the first extension portion and the second extension portion, and are spaced apart from one another in the first direction.

17. The display apparatus of claim 16, wherein:
the first extension portion at least partially overlaps the gate electrode; and
the second extension portion and the gate electrode do not overlap one another.

18. The display apparatus of claim 16, wherein:
the first connection portion at least partially overlaps a corresponding one of the first common voltage lines; and
the second connection portion at least partially overlaps a corresponding one of the second common voltage lines.

19. The display apparatus of claim 15, wherein:
the first substrate further comprises odd numbered gate lines and even numbered gate lines disposed in an alternating arrangement;
first ones of the thin film transistors are electrically connected to the odd gate lines;
second ones of the thin film transistors are electrically connected to the even gate lines; and
some of the first ones of the thin film transistors are inversely disposed with respect to some of the second ones of the thin film transistors.

20. The display apparatus of claim 16, wherein a distance between the first connection portion and the second connection portion in the first direction is larger than the width of the gate electrode in the first direction.
